(19) United States
(12) Patent Application Publication
(10) Pub. No.: US 2008/0189690 A1
(43) Pub. Date: Aug. 7, 2008

(54) METHOD FOR PERSISTING OR TRANSFERRING AN XCODES EXECUTION PLAN IN A SELF-CONTAINED, PLATFORM INDEPENDENT FORMAT

(75) Inventors: Abraham Heifets, Cambridge, MA (US); Margaret Gaitatzes Kostoulas, Veria (GR); Michelle A. Leger, Edgewood, NM (US); Moshe E. Matsa, Cambridge, MA (US); Eric Perkins, Boston, MA (US); Daniel Pinto de Mello e Silva, Bradenton, FL (US)

Correspondence Address: CANTOR COLBURN LLP-IBM YORKTOWN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/670,099

(22) Filed: Feb. 1, 2007

(51) Int. Cl. G06F 9/45

(52) U.S. Cl. 717/147

(57) ABSTRACT

A method for constructing and executing an XCodes execution plan stored in a self-contained, platform-independent format, the method comprising: providing a plurality of Extensible Markup Language (XML) documents each having content, structure, and a plurality of instruction; identifying a language in which the content of the plurality of XML documents is written; converting the language to a set of abstract, platform-independent instructions (XCodes) representing the structure of the plurality of the XML documents, via a compilation step; converting the set of abstract, platform-independent instructions (XCodes) to a highly optimized, platform-specific form via a loading process; mandating an instruction-space allocation; allowing one or more extension instruction into the XCodes execution plan; setting symbolic references to the one or more extension instructions; ignoring the one or more extension instructions having the symbolic references; and constructing implementation-specific tables.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to parsing and validation of XML documents, and particularly to a method for representing the XCodes parsing and validation execution plan by using an abstract, platform-independent language.

2. Description of Background

Bytecode-compiled systems use a highly specific stream of instructions to represent an execution plan for parsing and validation. The instructions themselves, in abstract, are not platform or target-language specific, but they are an in-memory representation that is highly tuned for the target platform. This instruction stream, which is produced by a compiler, is passed to the machine in some form.

In typical interpreters (tel, lisp, java, etc.) instruction streams are created in a binary, byte-code form, which is passed to the interpreter, as well as stored on disk for reuse. This method, while straightforward, has the disadvantage of binding the representation of the instructions to the execution environment on which they are used. This close binding between the compiled form and the execution environment imposes rigid constraints on the possible variability of the execution environments. The byte-code interpreters are thus truly virtual machines, with a rigid, virtual environment.

High-level, domain-specific virtual machines, as for example the high-level virtual machine for parsing and validation of xml documents, can be hosted on a wide variety of native environments. Indeed, in the referenced system, separate implementations have been designed for both a directly compiled native environment (written in the C language), and a general purpose, low-level virtual machine (Java language). These two platforms pose divergent strengths and weaknesses, and thus the binary, in-memory instruction stream representations for the two platforms are quite dissimilar.

In addition to the practical difficulties of sharing a binary instruction representation between several target platforms, binary instruction streams are difficult to extend. Since all instructions in a given stream must be at least partially understood by every interpreter (at least enough to disregard them, and to distinguish the difference between unsupported extensions, and corruptions in a completely standard instruction stream), the extension instructions must also be partially understood by every interpreter. For real extensibility to work, then, the instructions must be self-describing. This creates an overhead (in both time and size) for extension instructions, thus limiting their usefulness.

Considering the above limitations, it is desired to have a high-level platform-independent representation of the instruction stream that can be shared among disparate virtual machine implementations, allowing for greater reusability of the byte-code compilation engine.

### SUMMARY OF THE INVENTION

The shortcomings of the prior art are overcome and additional advantages are provided through the provision of a method for constructing and executing an XCodes execution plan stored in a self-contained, platform-independent format, the method comprising: providing a plurality of Extensible Markup Language (XML) documents each having content, structure, and a plurality of instruction; identifying a language in which the content of the plurality of XML documents is written: converting the language to a set of abstract, platform-independent instructions (XCodes) representing the structure of the plurality of the XML documents, via a compilation step; converting the set of abstract, platform-independent instructions (XCodes) to a highly optimized, platform-specific form via a loading process; mandating an instruction-space allocation; allowing one or more extension instruction into the XCodes execution plan; setting symbolic references to the one or more extension instructions; ignoring the one or more extension instructions having the symbolic references; and constructing implementation-specific tables.

The shortcomings of the prior art are overcome and additional advantages are provided through the provision of a computer program product for constructing and executing an XCodes execution plan stored in a self-contained, platform-independent format, the computer program product comprising: a storage medium readable by a processing circuit and storing instruction for execution by the processing circuit for performing a method comprising: providing a plurality of Extensible Markup Language (XML) documents each having content, structure, and a plurality of instructions; identifying a language in which the content of the plurality of XML documents is written; converting the language to a set of abstract, platform-independent instructions (XCodes) representing the structure of the plurality of the XML documents, via a compilation step; converting the set of abstract, platform-independent instructions (XCodes) to a highly optimized, platform-specific form via a loading process; mandating an instruction-space allocation; allowing one or more extension instructions into the XCodes execution plan; setting symbolic references to the one or more extension instructions; ignoring the one or more extension instructions having the symbolic references; and constructing implementation-specific tables.

Additional features and advantages are realized through the techniques of the present invention. Other embodiments and aspects of the invention are described in detail herein and are considered a part of the claimed invention. For a better understanding of the invention with advantages and features, refer to the description and the drawings.

### TECHNICAL EFFECTS

As a result of the summarized invention, technically we have achieved a solution for representing an XML parsing and validation execution plan by using XCodes, an abstract, platform-independent language.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates an example of an abbreviated table section of an XCode file;

FIG. 2 illustrates a hand-written example of the steps executed by a Java version of an XCode file Loader; when loading the section presented in FIG. 1;

FIG. 3 illustrates an example of an abbreviated element-handler section of an XCode file;

FIG. 4 illustrates a hand-written example of some of the steps executed by the XCode Loader, when loading the section of the XCodes file presented in FIG. 3;

FIG. 5 illustrates one example of an abbreviated content-handler section of an XCode file; and

FIG. 6 illustrates one example of information added to a native stream by a corresponding loader response.

### DETAILED DESCRIPTION OF THE INVENTION

One aspect of the exemplary embodiments is a method for using an XML-based language that represents the XCode instruction set in an abstract form, without inference to its platform specific in-memory representation. Another aspect of the exemplary embodiments is a method wherein this representation is designed, explicitly, to make no such references (instruction numbers, stream offsets, etc.) while still retaining the low-level flow-control model of an instruction set. In yet another exemplary embodiment, a simple loading process converts this form to a platform-optimal representation when execution begins. The XML format provides a built-in extensibility mechanism, as well as simple means of verifying the integrity of the instruction stream.

As an example of the implementation independence, the XCode execution plan uses only symbolic (i.e., named) references to instruction, rather than integer codes, which would mandate a particular instruction-space allocation. Furthermore, all cross-references in the set are symbolic (i.e., indirected by name, rather than by offset). The language is also designed to allow the introduction of optional extension instructions into the execution plan. Through established conventions, these instructions are easily identified, and ignored by interpreter implementations that do not support them, but equally easily integrated into the native instruction stream by interpreters that do.

The embodiment of this language is an XML dialect, which is described below. The XML syntax provides a convenient platform-neutral exchange format, and through the use of namespaces, provides a natural system of conventions to support extensibility. While not required to be materialized on disk (the XML language can easily be realized in memory with any of the usual, standard APIs), the XCodes language also provides a useful physical artifact to cache the results of a compilation that may involve many configuration options, and input schema documents.

On the interpreter side, the XCodes language is converted to a highly optimized, platform-specific in-memory form through a simple loading process, where the symbolic references are resolved, extension instructions are resolved or ignored, and various implementation-specific tables constructed. In this way, the final program representation is carefully optimized for the specific virtual machine, but the compilation technology is not required to be tuned to any specific interpreter.

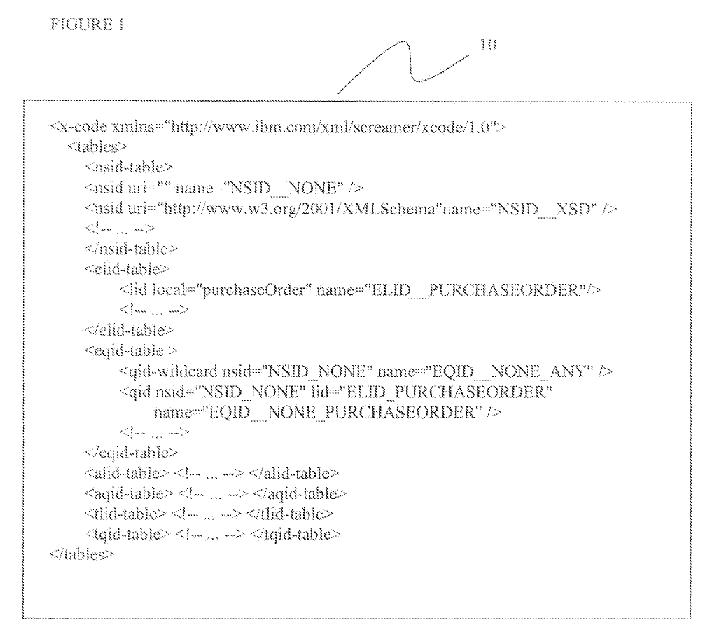

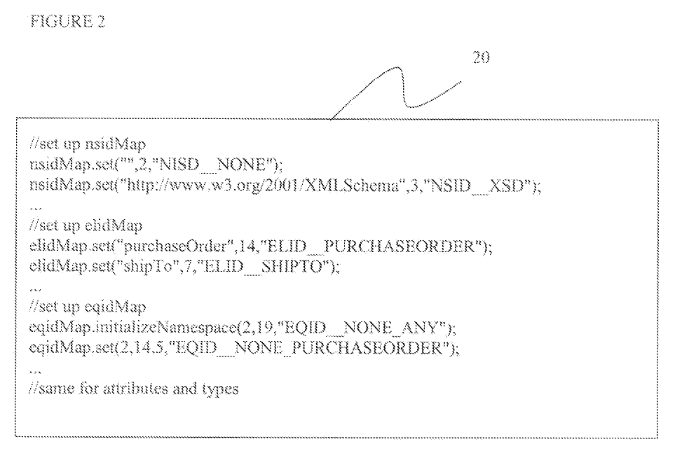

Referring to FIGS. 1 and 2, an example of x-code loading 10, contrasting the on-disk storage format with the platform-optimized native execution format is illustrated. The example is taken from the XCode file produced by a compiler when given the PurchaseOrder schema (described in the XML Schema Primer) as its input. For the pseudo-code, the mechanics of accessing the document, and looking up numeric identifiers for the text keys has been removed for brevity.

Referring to FIG. 2, the Java version of the XCode Loader reads in the code in FIG. 1 representing tables of information in the XCodes file, and executes code, duplicating the steps given in the code listing 20 (the numbers are calculated according to implementation specific rules). The Java version chooses a Java-specific data structure to represent the content of the <tables> in x-code 10 (see FIG. 1).

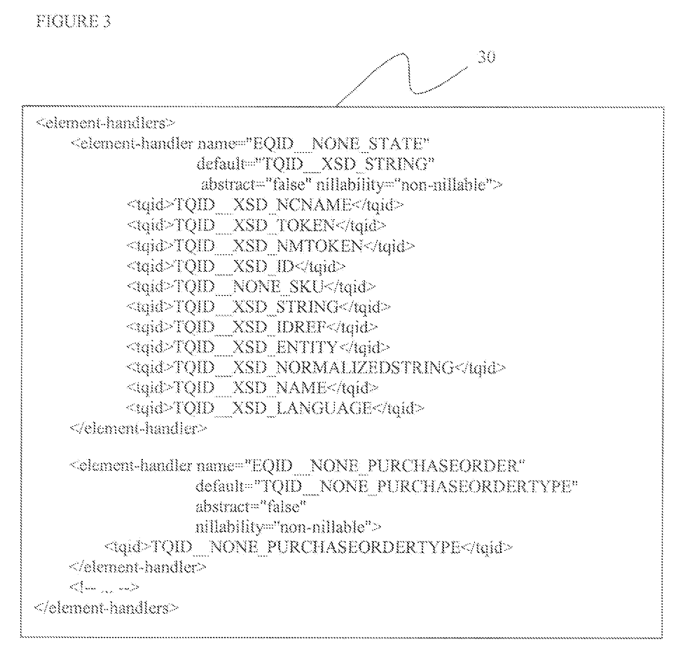

Referring to FIG. 3, an abbreviated element-handler section 30 of an XCode file is described (note the exclusive use of the text keys, defined above in <tables> in x-code 10). The element-handler for a <state> element (as indicated by EQID_NONE_STATE) specifies that the type of the element is, by default, xsd:string, and its possible subtypes can be TQID_XSD_NCNAME, TQID_XSD_TOKEN, TQID_XSD_NMTOKEN, etc.

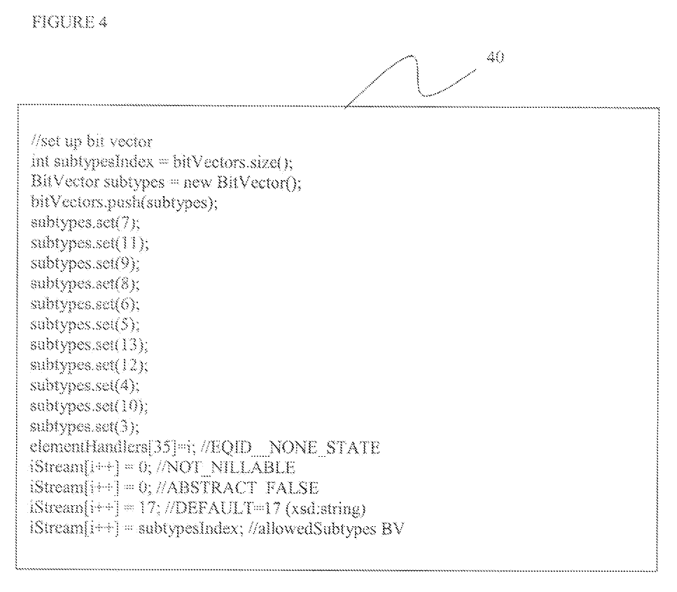

Referring to FIG. 4, the Loader code, on reading the <element-handler> section 30 for EQID_NONE_STATE executes code duplicating the steps given in listing 40 (inserting information into the native data stream, iStream): it creates a new BitVector to store the possible subtypes of EQID_NONE_STATE, sets the integer corresponding to each of the logical TQID_XSD_NCNAME, etc., specified in the element-handler, and adds instructions into the native data stream about other information like the element's nillable and is Abstract values, as well as information about the default type, and a pointer to the allowed subtype BitVector.

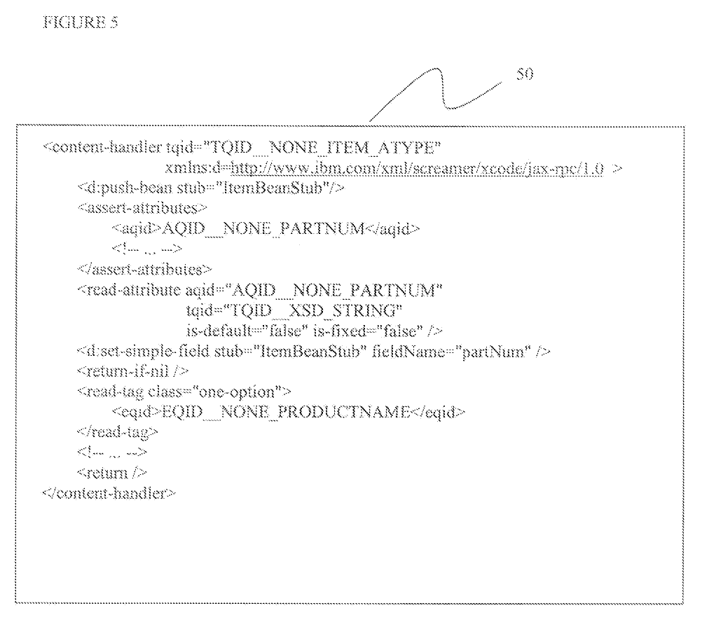

Referring to FIG. 5, an abbreviated content-handler section 50 of an XCode file is described. Note the use of extension instruction here for JAX-RPC (Java API for XML-based Remote Procedure Calls) deserialization, signified by the use of the d namespace in those extension instruction elements. The content handler for the type representing <item> elements in XML documents conforming to the PurchaseOrder schema (as signified by TQID_NONE_ITEM_ATYPE) contains information pertaining to the proper parsing and deserialization of the <item> type.

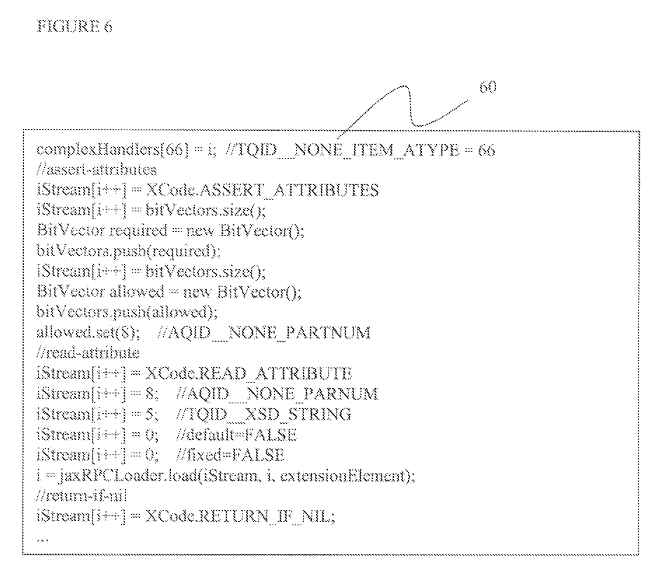

Referring to FIG. 6, the corresponding loader response adds the information 60 to the native data stream (note that the extension codes are loaded by a separate, extension-specific loader).

The native form of the instructions in the java-based interpreter is an array of integer data (instructions and their arguments), which reference a variety of more complicated tabular data (BitVector objects, HashMaps, etc.). This structure is an efficient in-memory representation for the given platform, but not necessarily for all platforms. Furthermore, depending on the characteristics of the particular Java virtual machine being used, a different representation might be more efficient, such as a more object oriented in-memory representation in which each instruction is its own object, and the stream is represented as a series of links between the instruction objects. Neither of these representations is prohibited or favored by the x-code file layout, which means that they can both share the same producer of XCode files (the compiler).

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for constructing and executing an XCodes execution plan stored in a self-contained, platform-independent format, the method comprising:
providing a plurality of Extensible Markup Language (XML) documents each having content, structure, and a plurality of instructions;
identifying a language in which the content of the plurality of XML documents is written;
converting the language to a set of abstract, platform-independent instructions (XCodes) representing the structure of the plurality of the XML documents, via a compilation step;
converting the set of abstract, platform-independent instructions (XCodes) to a highly optimized, platform-specific form via a loading process;
mandating an instruction-space allocation;
allowing one or more extension instructions into the XCodes execution plan;
setting symbolic reference to the one or more extension instructions;
ignoring the one or more extension instructions having the symbolic references; and
constructing implementation-specific tables.

2. A computer program product for constructing and executing an XCodes execution plan stored in a self-contained, platform-independent format, the computer program product comprising:
a storage medium readable by a processing circuit and storing instructions for execution by the processing circuit for performing a method comprising:
providing a plurality of Extensible Markup Language (XML) documents each having content, structure, and a plurality of instructions;
identifying a language in which the content of the plurality of XML documents is written;
converting the language to a set of abstract, platform-independent instructions (XCodes) representing the structure of the plurality of the XML documents, via a compilation step;
converting the set of abstract, platform-independent instructions (XCodes) to a highly optimized, platform-specific form a via a loading process;
mandating an instruction-space allocation;
allowing one or more extension instructions into the XCodes execution plan;
setting symbolic references to the one or more extension instructions;
ignoring the one or more extension instructions having the symbolic references; and
constructing implementation-specific tables.
